(19) United States
(12) Patent Application Publication
(10) Pub. No.: US 2007/0005347 A1
(43) Pub. Date: Jan. 4, 2007

(54) Method and apparatus for data frame construction

(76) Inventor: Michael D. Kotzin, Buffalo Grove, IL (US)

Correspondence Address: MOTOROLA INC, 600 NORTH US HIGHWAY 45, ROOM AS437, LIBERTYVILLE, IL, 60048-5343, US

(21) Appl. No.: 11/171,072

(22) Filed: Jun. 30, 2005

(51) Int. Cl. G10L 11/00

(52) U.S. Cl. 704/200

(57) ABSTRACT

A method of data coding is disclosed. The method comprises (204) generating a plurality of transmission frames (100) for a set of source information, wherein each transmission frame construction represents the entire set of source information. Each transmission frame construction comprises N speech frames, wherein each speech frame is coded with a coding scheme selected from a plurality of coding schemes. The method further comprises selecting (208) from the plurality of transmission frames a single transmission frame construction, which, when decoded provides the best perceptual reconstruction of the source information in comparison to the remaining transmission frames of the plurality of transmission frames.

### FIELD OF THE INVENTION

The present inventions relate generally to data coding, and more particularly to a method and apparatus for code rate optimization.

### BACKGROUND OF THE INVENTIONS

The throughput of a digital communication channel is often limited. In other words, a digital communication channel may only allow a fixed number of bits per second to be transmitted from a source to a destination. There are many additional factors that further limit the rate of communication. For example, in a packet communication system, such as a voice over internet protocol (VoIP) systems, there is an overhead associated with the IP packets. Further when the system is a wireless system, there may be additional overheads, such as channel coding used for error correction, channel control, supervision, etc.

The limitation on available channel rate constrains the amount of bits available for the actual information desired to be conveyed, such as voice or video. This may limit the particular type of digital coding which may be employed to encode the information, such as voice or video. For example, it might be necessary to use a half rate speech coder instead of a full rate speech coder. This has the disadvantage of resulting in degraded speech quality when the speech is reconstructed at the destination. There is also a desire to limit the amount of delay in the system to provide the communications as real-time as possible

The various aspects, features and advantages of the present inventions will become more fully apparent to those having ordinary skill in the art upon careful consideration of the following Detailed Description of the Drawings with the accompanying drawings described below.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an exemplary representation of possible frame constructions.

FIG. 2 is an exemplary flow diagram for selecting transmission frame construction.

FIG. 3 is an exemplary representation of a possible sequence of transmission frames.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE DRAWINGS

Before describing in detail exemplary embodiments that are in accordance with the present invention, it should be observed that the exemplary embodiments reside primarily in combinations of method steps and apparatus components related to constructing a frame for transmission. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

A method and apparatus for transmission frame construction is disclosed. The method comprises generating a plurality of transmission frames of a set of source information wherein each transmission frame construction represents the entire set of source information. Each generated transmission frame comprises a group of N differently coded speech frames. Each speech frame is coded with a coding scheme selected from a plurality of coding schemes. For example, a speech frame might be coded at a first sample rate or a second sample rate. Then the method comprises selecting from the generated plurality of transmission frames a single transmission frame construction, which, when decoded provides the best perceptual reconstruction of the source information in comparison to the remaining transmission frames of the plurality of transmission frames. A coding descriptor identifies the particular construction used in a selected transmission frame. In one exemplary embodiment the selected transmission frame and a coding descriptor make up at least a portion of a data packet. The single transmission frame construction and the descriptor are transmitted to the desired destination. The desired destination may be another device, a packetizer of the device to insert the transmission frame into a packet, to memory for comparison to another selected single transmission frame construction, for example.

The communication device may be a mobile communication device or wireless communication device or any combination thereof. The mobile wireless communications device may be a wireless cellular telephone, or a two-way pager, or a wireless enabled personal digital assistant (PDA) or notebook or laptop computer, or some other radio communications device, any one of which may be a cellular communications service subscriber device.

It is further understood that the use of relational terms, if any, such as first and second, and the like are used solely to distinguish one from another entity or action without necessarily requiring or implying any actual such relationship or order between such entities or actions. Much of the inventive functionality and many of the inventive principles are best implemented with or in software programs, algorithms or instructions and integrated circuits (ICs) such as a processor, microprocessors, controllers, application specific ICs or the like. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts according to the present invention, further discussion of such software and ICs, if any, will be limited to the essentials with respect to the principles and concepts within the preferred embodiments.

Packet data systems, such as the network commonly referred to as the internet, send information divided into packets. In one exemplary embodiment, the entire packet is split into three parts: a header, the payload, also referred to as the body or data, and a trailer or footer which may include error correction such as the cyclic redundancy check (CRC) or the like. The sequence of frames (or transmission frame construction) made up of sub-frames (e.g. speech frames) make up at least a portion of the packet. In general the speech frames of the transmission frame construction are temporally contiguous. When the packet is sent at least partially over a wireless connection, information or overhead related to the wireless connection must also be included in the packet.

The header may contain instructions about the data carried within the packet. These instructions may include: length of packet, synchronization, packet number, protocol (on networks that carry multiple types of information, the protocol defines what type of packet is being transmitted (i.e. e-mail, streaming video, streaming audio, URL information or the like), destination address and the originating address.

The payload, also called the body or data of the packet, is the actual data which the packet is delivering from the originating address to the destination. A payload may be fixed or variable in length from packet to packet. In this exemplary embodiment, a fixed length payload is used for illustrative purposes. A fixed length payload simplifies the conveyance of a fixed duration of information, speech for example, from a source to a destination while holding the delay of information over the channel. Fixed length payloads are also compatible with many wireless communication systems utilizing fixed framing of information. Some exemplary systems include cellular systems such as CDMA, GSM, TDMA, WCDMA or the like. In this exemplary embodiment five speech frames make up the speech data contained in a transmission frame. It is to be understood that the number of speech frames, five frames in this embodiment, is exemplary. Also in this exemplary embodiment, the transmission frame plus the ID would be included in the payload. It is to be understood by one of ordinary skill in the art that the use of speech as the source information is exemplary only and that any data may be the source information.

The packet trailer may contain a small number of bits that indicate the end of the packet and it may include error checking.

This particular invention contemplates that the encoding of speech frames using full and half rate speech coding. With a fixed frame system, not al frames may be coded at a full rate. On the other hand, there would be unused bits in the packet if all speech frames were coded using half rate. A combination of full rate speech frames and half rate speech frames is incorporated. In this exemplary embodiment, the full rate speech frames and half rate speech frames are in the proportion of two to three respectively. For example each transmission frame, which is incorporated into the packet payload along with the coding descriptor, will contain exactly two speech frames coded with full rate and three speech frames coded with half rate coding. The quality of the resultant speech when reconstructed from the coded information will be better than speech that has been coded completely with a half rate coder, although not quite as good as if the speech had been coded completely with a full rate coder.

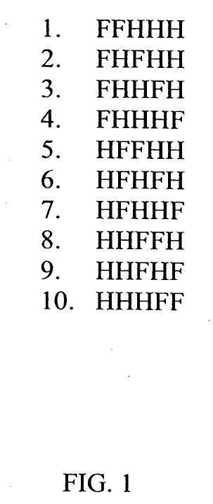

FIG. 1 illustrates exemplary constructions of all possible frames for transmission (i.e. transmission frames), coding all the speech frames with both a first coding mode and a second coding mode. In this exemplary embodiment, there are 10 possible combinations of two full rate speech frames with two half rate frames. This exemplary set of transmission frames 100 shown include a first transmission frame construction 102, a second transmission frame construction 104, a third transmission frame construction 106, a fourth transmission frame construction 108, a fifth transmission frame construction 110, a sixth transmission frame construction 112, a seventh transmission frame construction 114, an eighth transmission frame construction 116, a ninth transmission frame construction 118 and a tenth transmission frame construction 120. Each transmission frame construction has five speech frames in this exemplary embodiment. Each transmission frame construction represents a possible construction of the transmission frame from the same speech information; however for each transmission frame construction, the speech information is coded with a different coding scheme. In this exemplary embodiment, the full rate coded speech frames are represented by an “F” and the half rate coded speech frames are represented by an “H.”

The number of frames per packet in this exemplary embodiment is determined by the equation:

$$\frac{5 !}{3 ! \times 2 !} ⇒ 10$$

transmission frame construction combinations
This calculation assumes:
five frames of data per packet;
three frames are half rate frames; and
two frames are full rate frames.

The exemplary first transmission frame construction 102 is shown having a full rate first speech frame 122 wherein the data is sampled at a full rate followed by a full rate second speech frame 124 wherein the data is also sampled at a full rate. These frames are followed by three half rate speech frames 126, 128 and 130 wherein the data is sampled at a half rate. The second exemplary transmission frame construction 104 is shown having a full rate first speech frame 132, a half rate second speech frame 134, a full rate third speech frame 136, a half rate fourth speech frame 138 and a half rate fifth speech frame 140. In this embodiment the full rate frames will comprise a number of bits twice that of a full rate frame. Each transmission frame construction may have a number of bits no greater than a maximum allowable number of bits. Each speech frame however may have a different number of bits from the next speech frame. In this exemplary embodiment, the full rate frames would be made of more bits than the half rate frames. However, it should be noted that since for each construction there are the same number of full and half rate frames, each constructions will have exactly the same number of bits.

In this embodiment, a first number of bits required to represent a first number of speech frames is no greater than a first number of total bits, i.e. the maximum allowable number of bits. 3. In this embodiment, the first number of total bits is equal to the bit rate associated with a first bandwidth minus the number of bits required for internet protocol information and minus the number of bits required for wireless overhead information.

The particular transmission frame construction may be selected to optimize the data quality when constrained by a maximize amount of data throughput capability, e.g. a maximum packet size (i.e. fixed payload) which allows for the transmission of the number of bits required by the transmission frames. In one exemplary embodiment such as the packet system, where a certain number of speech frames are blocked into a packet, optimizing quality is desired for sending speech with a maximum packing buffer of 100 milliseconds. If the speech coder uses 20 millisecond frames, each packet must have five speech frames. Due to the packet, i.e. internet protocol, and signaling overhead, it is determined that the rate of the channel or the average speech information may only be 5600 bits per second (bps). The exemplary speech coder used to code the speech data, has a full rate of 8000 bps and a half rate of 4000 bps. Therefore, it may be determined for the particular throughput-limited communications system that each transmission frame may contain two full rate frames and three half rate frames.

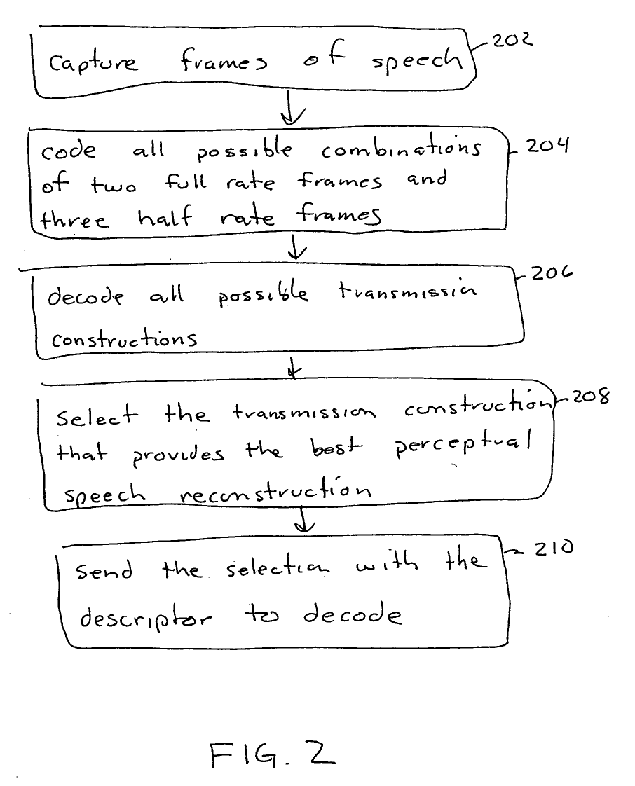

In this embodiment, illustrated in the exemplary flow diagram of FIG. 2, the exemplary method for selecting the particular coding of the transmission frame. The method comprises capturing 202 five 20 millisecond frames of raw speech information. Then, a processor codes 204 the speech information 10 times, each time generating one of the 10 possible constructions of the plurality of coded transmission frames for the same set of source information. Each transmission frame construction is made up of five speech frames, and each speech frame selected from a plurality of combination of two full rate and three half rate codings of the source information.

The processor in 206 decodes all 10 of the possible transmission frame constructions to provide the representative speech that would be created at the receiver for each received packet. As known in the art, information from the previously transmitted packet is used to “setup the state” of the speech coder for coding the newly received speech information. In 204, the single transmission frame construction of the possible 10 which, when decoded provides the best perceptual reconstruction of the original source information, is selected 208. It is to be understood that methods for perceptual assessments of reconstructed speech are well known in the art. For example linear predictive coding (LPC) is one type speech coders that determines the best perceptual reconstruction of the original source information. In this exemplary embodiment, for example, the eighth transmission frame construction 116 may provide the best perceptual reconstruction of the original source information when decoded. The eighth transmission frame construction 116 would be chosen for transmission in the packet. The proper coding descriptor is included in the packet indicating to the receiver, and decoder) how the selected transmission frame construction was coded and enabling the decoder to decode the selected transmission frame construction. In 205, the packet is transmitted.

One exemplary method of selecting the best of the ten possible transmission frame constructions to transmit may be accomplished using a scheme that is well known methods in the speech coding art, for example, analysis-by-synthesis coders such as code-excited linear predictive coders (CELP). In the CELP method, part of the coding algorithm for each speech frame relies on determining an excitation that should be used to excite an LPC filter. The LPC filter coefficients as well as information identifying a particular excitation, among other things, is then transmitted to the receiver.

The excitation sequence is determined by selecting from a set of possible pseudorandom innovation sequences. At the speech coder, each possible innovation sequence is iteratively tested by correspondingly exciting the determined LPC filter based on the innovation sequence. After appropriately filtering the signals with a perceptually weighted filter a distortion measure is obtained by processing the difference between the resultant synthesized speech out of the LPC filter and the original input speech. This is done for each possible innovation sequence and its corresponding excitation. The code representing the innovation sequence providing the lowest distortion measure is selected transmitted.

In one exemplary embodiment of the present invention, the process for selecting which transmission frame construction comprises using each of the ten possible transmission frame constructions to resynthesize the speech. A distortion metric is obtained by processing the difference between this synthesized signal and the original speech information after appropriate perceptual weighted filtering is applied. The transmission frame selected is the one which produces the lowest distortion in this embodiment.

Once the single transmission frame construction with the best decoded perceptual reconstruction is selected from the generated plurality of transmission frames, it may be processed by inserting the selected single transmission frame construction into a packet for transmission in one exemplary embodiment. In this exemplary embodiment the selected transmission frame construction is sent 210 or transmitted.

In another exemplary embodiment, the selected 208 single transmission frame construction may be used as a starting point to generate a second plurality of transmission frames of the same data set. In this exemplary embodiment, the second plurality of transmission frames are similar in structure to the selected single transmission frame construction. Then from the second plurality of transmission frames a second single transmission frame construction with the best decoded perceptual reconstruction is selected. The second single transmission frame construction is compared to the first single transmission frame construction to determine which has the best decoded perceptual reconstruction. If the second single transmission frame construction selected from the second plurality of transmission frames has a better decoded perceptual reconstruction then the first single transmission frame construction, then the single transmission frame construction may be, for example, transmitted or used as another starting point in a third iteration to select the transmission frame construction with the best decoded perceptual reconstruction.

For example, in the exemplary embodiment shown in FIG. 1, the plurality of sequences that are generated may be the first transmission frame construction 102, the fourth transmission frame construction 108, the seventh transmission frame construction 114 and the tenth transmission frame construction 120 are shown. Four out of the ten possible transmission frames are generated. This may be done to reduce processing time, memory usage, current drain and the like, particularly as the number of transmission frame construction possibilities increases.

In yet another embodiment, the coding scheme is selected based on speech type. For example the speech energy present in each of the five speech frames is determined. The two frames having the highest energy are coded using full rate and the remainder with half rate. In this way, the most energetic information is most accurately coded. It is understood that there are many other ways that might be used to determine which particular construction of the transmission frames out of the total possible constructions should be used for actual packet transmission.

In still yet another exemplary embodiment, the best perceptual reconstruction quality is determined as the packet having the most full-rate frames.

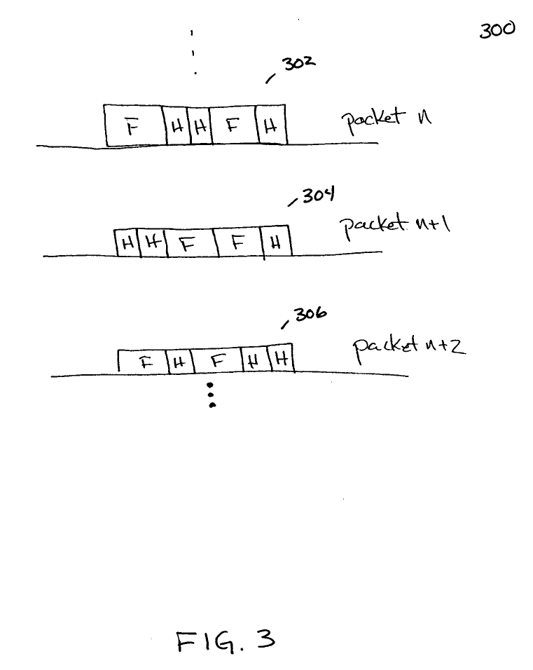

FIG. 3 illustrates multiple exemplary transmission frames 300 that may be incorporated into sequential packets having transmission frames coded with different coding schemes. Each transmission frame construction uses the coding scheme resulting in the best perceptual reconstruction for that particular 100 millisecond segment of speech. In this embodiment, exemplary packet n 302 has a transmission frame construction with a full rate first speech frame, a half rate second speech frame, a half rate third speech frame, a full rate fourth speech frame and a half rate fifth speech frame. The n+1st packet 304 has a transmission frame construction having a first, second and fifth sub-frames or speech frames coded with half rate and the third and fourth sub-frames being full rate.

In one exemplary embodiment, a speech frame coded with a lower quality coding scheme such as at a half rate, is replaced with another data set. The ability to choose which frame to replace with other data such as control information or signaling data for example, allows the system to selectively choose a speech frame with lower perceptual reconstruction quality instead of a higher quality frame thereby minimizing the effect on the quality of speech received at the destination.

While the present inventions and what are considered presently to be the best modes thereof have been described sufficiently to establish possession by the inventors and to enable those of ordinary skill to make and use the inventions, it will be understood and appreciated that there are equivalents to the exemplary embodiments disclosed herein and that many modifications and variations may be made thereto without departing from the scope and spirit of the inventions, which are to be limited not by the exemplary embodiments but by the claims appended hereto.

What is claimed is:

1. A method of data coding comprising:
generating a plurality of transmission frames for a set of source information, wherein each transmission frame construction represents the entire set of source information, and wherein each transmission frame construction comprises N speech frames, wherein each speech frame is coded with a coding scheme selected from a plurality of coding schemes; and
selecting from the plurality of transmission frames a single transmission frame construction, which, when decoded provides the best perceptual reconstruction of the source information in comparison to the remaining transmission frames of the plurality of transmission frames.

2. The method of claim 1, transmitting the single transmission frame construction.

3. The method of claim 2, transmitting a coding descriptor to the destination.

4. The method of claim 1, generating a second plurality of transmission frames, different than the first plurality of transmission frames, for the set of source information, wherein each speech frame is coded with a coding scheme selected from a plurality of coding schemes having similar properties to the selected single transmission frame construction; and
selecting from the plurality of transmission frames a second single transmission frame construction, which, when decoded provides the best perceptual reconstruction of the source information in comparison to the selected single transmission frames.

5. The method of claim 1, wherein a first number of bits required to represent a first number of speech frames is no greater than a first number of total bits.

6. The method of claim 5, wherein the first number of total bits is equal to the bit rate associated with a first bandwidth minus the number of bits required for internet protocol information and minus the number of bits required for wireless overhead information.

7. The method of claim 1, wherein the coding scheme selected from a plurality of coding schemes is selected to optimize the number of high bit rate data frames per a given transmission frame construction.

8. The method of claim 1, selecting from the plurality of coding schemes a combination of coded speech frames wherein at least two different coding schemes are used to code the speech frames of the sequence of frames.

9. The method of claim 8, coding the speech frames with a half rate sampling rate and a full rate sampling rate.

10. The method of claim 1, coding all the speech frames with both a first coding mode and a second coding mode; and
generating all combinations of the coded speech frames and to generate the plurality of transmission frames.

11. The method of claim 1, generating all possible combinations of speech frames with a code scheme.

12. A method for encoding data comprising:
determining the number of frames to make up a transmission frame construction based on a maximum data throughput and the number of potential coding schemes;
generating a plurality of transmission frames to be generated from a single data set, each transmission frame construction of the plurality of transmission frames having a unique coding scheme and no more data than the maximum data throughput; and
selecting a single transmission frame construction from the plurality of transmission frames, the single transmission frame construction having the best perceptual reconstruction relative to the remaining frames sequences of the plurality of transmission frames.

13. The method of claim 12, generating a coding descriptor to send to the decoder.

14. The method of claim 13, sending the single transmission frame construction having the best perceptual reconstruction and the coding descriptor to the destination.

15. A method of data coding comprising:
generating a plurality of transmission frames from a first data set, wherein each transmission frame construction is coded with a different coding scheme; and
selecting a first transmission frame construction having the best perceptual quality of the first data set.

16. The method of claim 15, wherein the coding scheme comprises coding at least one frame at a first sample rate and at least one frame at a second sample rate.

17. The method of claim 15, wherein the coding scheme comprises coding at least a first frame of the transmission frame construction with a first coding mode and at least a second frame with a second coding mode.

18. The method of claim 15, selecting a first transmission frame construction having the best perceptual quality when compared to the first original source information.

19. The method of claim 15, selecting a coding scheme based on speech type.

20. The method of claim 19, wherein speech type is active speech, inactive speech, or speech energy.

21. The method of claim 12, generating all combinations of transmission frames possible based on a fixed number of coding schemes.

22. The method of claim 12, generating all combinations of transmission frames possible based on a data bits available or data rate.

23. The method of claim 12, generating all combinations of transmission frames possible based on a packet size.

24. The method of claim 16, determining that the best perceptual reconstruction quality is the transmission frame construction having the most full-rate sampled frames.

25. The method of claim 16, replacing a frame coded at a half-rate with a second data set not related to the first data set.

26. The method of claim 15, wherein the transmission frame construction and a coding scheme descriptor make up a portion of a data packet.

27. The method of claim 15, wherein the first data set are portions of a data stream.
